(19) United States
(12) Patent Application Publication
(10) Pub. No.: US 2007/0279672 A1
(43) Pub. Date: Dec. 6, 2007

(54) IMAGE PROCESSING APPARATUS AND IMAGE PROCESSING METHOD

(75) Inventor: Koji Harada, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/754,504

(22) Filed: May 29, 2007

(30) Foreign Application Priority Data
Jun. 2, 2006 (JP) 2006-155397

(51) Int. Cl. G06K 15/00

(52) U.S. Cl. 358/1.14

(57) ABSTRACT

An image processing apparatus for generating a document image, which enables to mask confidential information at the time of outputting the confidential information, includes: a document input unit adapted to input a document image having a character image; a masking position setting unit adapted to set masking position data indicative of a masking target position on the document image; a mask data insertion unit adapted to insert mask data in the input document image, the mask data indicating that the character image corresponding to the masking position data is a masking target; and a document output unit adapted to output the document image in which the mask data is inserted.

### BACKGROUND OF THE INVENTION

1. Field of the Invention

The present invention relates to an image processing apparatus and an image processing method, and more particularly, to an image processing apparatus and an image processing method for masking confidential information in a document image.

2. Description of the Related Art

With regard to the protection of privacy, it is an extremely important issue for apparatuses dealing with personal information to carry out a function for a measure that prevents personal information from being leaked.

Conventionally, various techniques have been proposed for redacting personal information, such as masking or daubing the personal information black before printing.

For instance, Japanese Patent Laid-Open No. 2004-318875 discloses the following technique. An original document is read by a scanner, and coordinate data of the personal information thereupon is input by a coordinate data input apparatus. In accordance with the input data, a first data that is personal information is separated from a second data that is information other than the personal information. Masking is performed on the first data, with digitalizing or printing executed thereafter.

Furthermore, Japanese Patent Laid-Open No. 2004-17538 discloses a technique for bar-coding personal information, synthesizing the bar-code with a company logo, and including the personal information as hidden data.

Furthermore, according to Japanese Patent Laid-Open No. 2005-236843, print-target document generation processing is divided into a document generation step and a document editing step. In the document generation step, ornament processing data to be added, e.g., masking, deletion and the like, as well as coordinate data indicative of a particular area, are embedded in the background as bar-codes and digital watermarks. In the document editing step, processing, such as masking, is performed in accordance with the data embedded in the background.

However, according to the technique disclosed in Japanese Patent Laid-Open No. 2004-318875, it is necessary to input coordinate data indicative of the position of personal information in the original document each time the document is read. This is unfavorable when executing masking for a large number of pages.

Furthermore, according to the technique disclosed in Japanese Patent Laid-Open No. 2004-17538, if there is no company logo in a document, there is no place to conceal the personal information, and in such a situation, it is unclear how personal information should be handled. Moreover, if a method for decoding the bar-codes that conceal personal information slips out, personal information can be easily leaked.

Furthermore, according to the technique disclosed in Japanese Patent Laid-Open No. 2005-236843 which suggests to embed, as digital watermarks, the ornament processing data such as masking, replacing and the like, as well as coordinate data indicative of masking positions, the following problems are raised. First, the amount of embedded data is massive. Moreover, if part of the document is missing, for instance, if the ornament data portion is cut out of the document, personal information masking cannot be ensured, thus resulting in a risk of information being leaked.

### SUMMARY OF THE INVENTION

The present invention has been proposed to solve the above-described problems. An image processing apparatus and a method that can ensure prevention of confidential information leak by masking, with certainty, a part of a document that contains confidential information are provided.

According to an aspect of the present invention, an image processing apparatus for generating a document image, which enables to mask confidential information at the time of outputting the confidential information, includes: a document input unit adapted to input a document image having a character image; a masking position setting unit adapted to set masking position data indicative of a masking target position on the document image; a mask data insertion unit adapted to insert mask data in the input document image, the mask data indicating that the character image corresponding to the masking position data is a masking target; and a document output unit adapted to output the document image in which the mask data is inserted.

According to another aspect of the present invention, an image processing apparatus for masking confidential information in a document image, includes: a masking position registration unit adapted to register masking position data, indicative of a masking target position on the document image, for each format of the document image; a document input unit adapted to input the document image; a masking unit adapted to mask the input document image based on the masking position data; and an output unit adapted to output the document image on which masking has been performed.

According to still another aspect of the present invention, an image processing method of generating a document image, which enables to mask confidential information at the time of outputting the confidential information, includes: inputting a document image having a character image; setting masking position data indicative of a masking target position on the document image; inserting mask data in the input document image, the mask data indicating that the character image corresponding to the masking position data is a masking target; and outputting the document image in which the mask data is inserted.

According to yet another aspect of the present invention, an image processing method of masking confidential information in a document image, includes: registering masking position data, indicative of a masking target position on the document image, for each format of the document image; inputting the document image; masking the input document image based on the masking position data; and outputting the document image on which masking has been performed.

Further features of the present invention will become apparent from the following description of exemplary embodiments, with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a functional configuration of an image processing system.

FIG. 2 is a flowchart illustrating registration of information indicative of a document format and masking positions.

FIG. 3 is a view showing an example of a form sheet.

FIG. 4 is a view showing an example of image data of the form including masking positions.

FIG. 5 is a flowchart illustrating generation of an information-embedded document.

FIG. 6 is a view showing an example of a character constructed by a dot pattern.

FIG. 7 is a flowchart illustrating masking processing on an information-embedded document.

FIG. 8 is a view showing rectangles of a character and its masking result.

FIG. 9 is a block diagram showing a functional configuration of an image processing system.

FIG. 10 is a flowchart illustrating masking processing on a document.

FIG. 11 is a block diagram showing a basic configuration of a computer system.

### DESCRIPTION OF THE EMBODIMENTS

Exemplary embodiments of the present invention will be described in detail, in accordance with the accompanying drawings. Note that the configuration described in the following embodiments is an example, and the present invention is not limited to the configuration illustrated below.

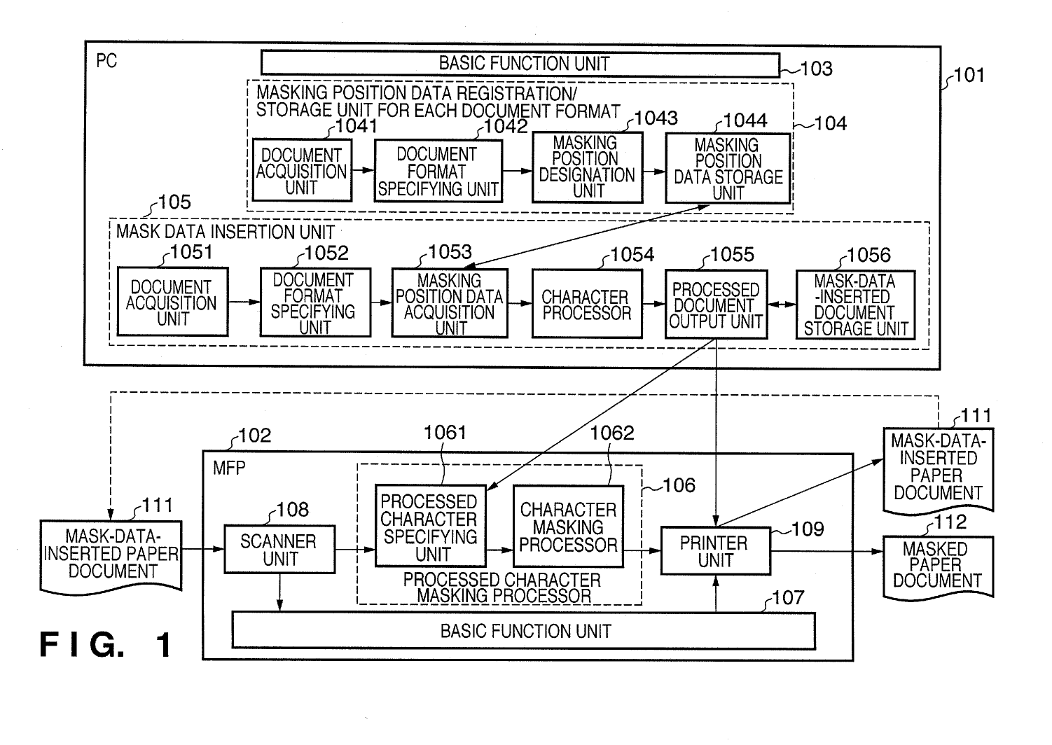

FIG. 1 is a block diagram showing a functional configuration of an image processing system according to a first exemplary embodiment. In FIG. 1, the image processing system according to the exemplary embodiment includes a personal computer (PC) 101 and a multi-function peripheral (MFP) 102 having multi functions, e.g., for copying, scanning, printing and the like. The PC 101 and MFP 102 are both connected to a network such as a LAN, and can exchange data such as images and protocol commands.

The PC 101 includes a basic function unit 103 that implements regular computer functions, e.g., calculation, display, input, output and the like. The PC 101 further includes a masking position data registration/storage unit 104 that registers and stores masking position data for each document format, and a mask data insertion unit 105 that processes a character that is subject to masking. It is presumed that drivers for controlling the printer, scanner, and FAX functions of the MFP 102, and that application software for document generation have already been installed in the PC 101.

The MFP 102 includes a basic function unit 107 that controls the basic functions of the MFP, e.g., copying, scanning, printing, image processing and the like, a scanner unit 108 that reads an original document, a printer unit 109 that outputs printing paper, and a processed character masking processor 106.

The first embodiment is implemented by the following three steps: registration of document format and its masking position, generation of information-embedded document, and masking processing on information-embedded document. Hereinafter processing in each of these steps is described in sequence.

### Registration of Document Format and Its Masking Position

The function is implemented chiefly by using the masking position data registration/storage unit 104 of the PC 101. To register and store information indicative of the document format and its masking position, it is presumed that dedicated registration application software for implementing the function, to be described hereinafter, is installed in the PC 101. Note that the registration processing may be implemented by software other than the dedicated registration application software. For instance, application software commonly used for document generation, e.g., Microsoft Word®, which is normally used in offices, or plug-in software of form generation software may implement the registration processing.

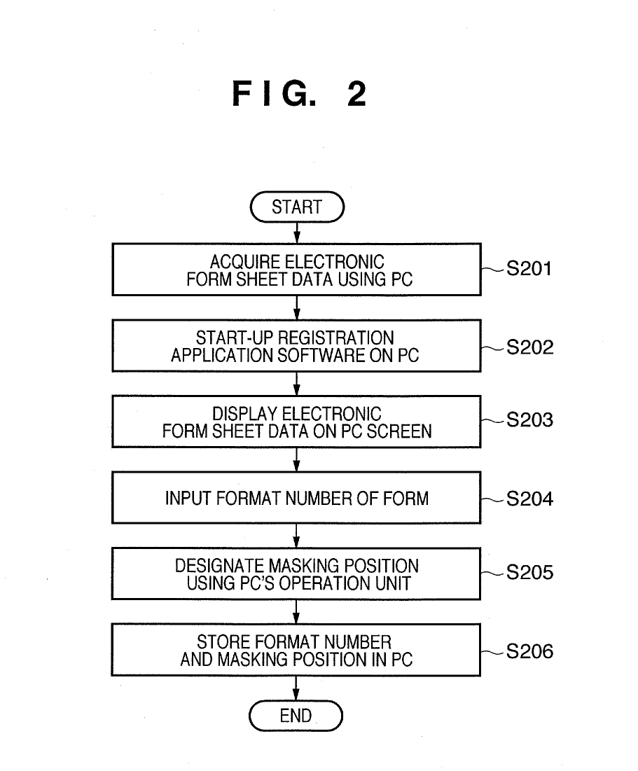

Following is a description of a flowchart of the registration processing, with reference to FIG. 2.

A user activates the scanner 108 of the MFP 102 through a driver (not shown) of the PC 101, and generates electronic data from blank sheets of respective forms. A document acquisition unit 1041 acquires the generated data, per step S201. If the PC 101 already has the form sheet data, the process can be omitted.

The user starts up the registration application software on the PC 101, per step S202, opens the electronic form sheet data acquired by the document acquisition unit 1041, and displays it on the screen, per step S203.

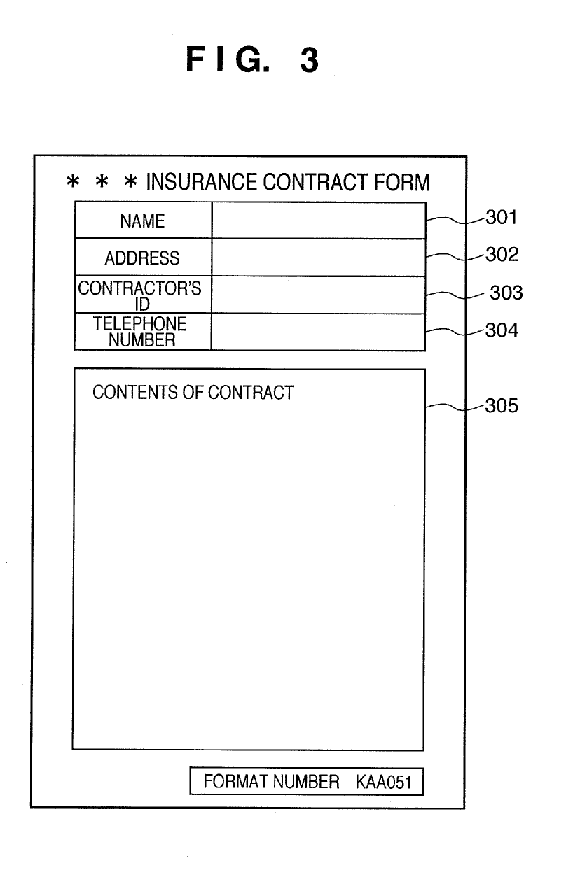

An example of a form sheet is shown in FIG. 3. The drawing shows an example of a blank form for an insurance contract. It is presumed herein that items including name 301, address 302, and telephone number 304 are personal information, while contractor's ID 303 is not personal information.

When the form is displayed on the PC 101, the PC 101 displays a message asking a user to input a format number of the form. In response, the user inputs a format number of the form using the operation unit. In the example of the form shown in FIG. 3, “KAA051” is the format number of the form. In the PC 101, the document format specifying unit 1042 obtains the input format number of the form and stores it, per step S204. Note that the format number of the form is determined in advance for each type of form, i.e., it is not a contract number. Therefore, a form can be specified by the number.

The user designates the personal information part of the form using the operation unit and the mouse of the PC 101. In the example shown in FIG. 3, the field positions of items 301, 302 and 304 are designated as the personal information part. In the PC 101, the masking position designation unit 1043 acquires the designated field position as the masking position data corresponding to the format number and stores it, per step S205.

The information indicative of the format number stored in the document format specifying unit 1042 and the position information of the field stored in the masking position designation unit 1043 are associated with each other, and stored in the masking position data storage unit 1044 as the masking position data for each form, per step S206.

Executing the above-described processing completes the registration of information indicative of the document format and its masking position.

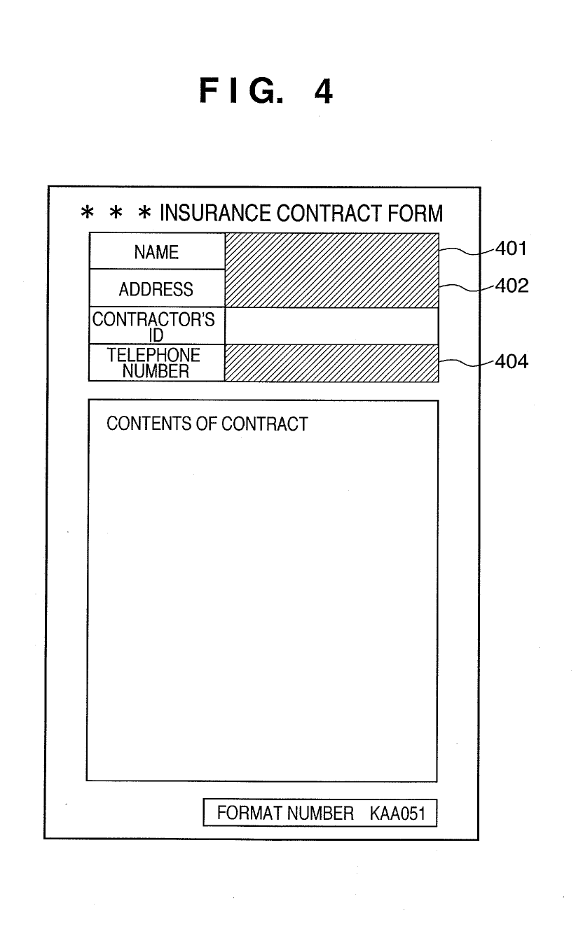

Note that, for a format of masking position data, in a case where the form data itself is stored in a data format such as XML, data such as “personal information=name, address, telephone number” may be stored. In a case where the form data is handled as image data, for instance, coordinate data indicative of the field position only, or the entire image data including masking positions, i.e., the filled portion shown in FIG. 4, may be stored.

The user needs to perform the registration processing for all forms to be used. For instance, a user who uses ten types of forms at work repeats the processing ten times to register on the server the masking position data of all forms to be used. Note that, instead of the user personally performing the registration operation, it is possible to consider a business model in which the registration operation is contracted out to a manufacturer which provides the service of form registration execution on behalf of the user.

### Generation of Information-Embedded Document

The function is implemented by mainly using the mask data insertion unit 105 of the PC 101. In the PC 101, form generation software used at work, and plug-in software, which implements the method, have already been installed. The function to be described below is implemented by the software.

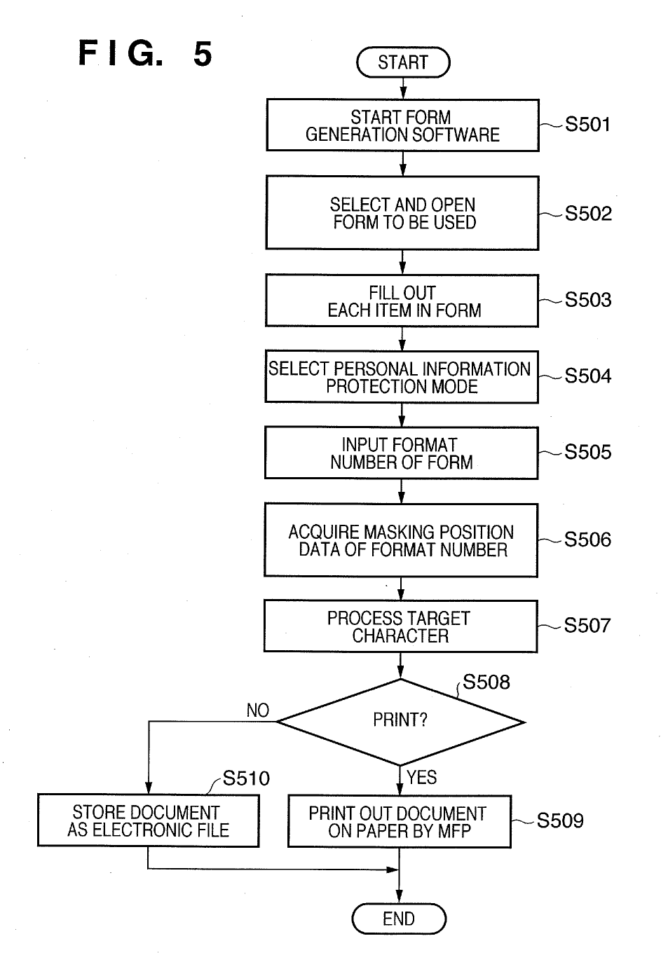

The document generation processing is described with reference to FIG. 5, which shows the flowchart of the processing.

The form generation software is started in the PC 101, per step S501. The form to be used is selected and opened, per step S502, and each item of the form is filled out, per step S503. For instance, in the form shown in FIG. 3, the customer's name 301, address 302, contractor's ID 303, telephone number 304, and contents of contract (i.e., contract terms and conditions) 305 are input in sequence. The procedure so far is similar to the regular form generation procedure.

Upon inputting respective items, personal information protection mode is selected from the menu of the application software, per step S504. The mode is added when the software that implements the document generation processing is plugged in to the application software.

The PC 101 uses a document acquisition unit 1051 to acquire and store the filled-out form, then displays a message asking the user to input the format number of the form on the next screen. In response, the user uses the operation unit of the PC 101 to input the number “KAA051” indicated at the bottom right of the form shown in FIG. 3, per step S505. The PC 101 uses the document format specifying unit 1052 to acquire and store the input number.

Note that the operation in step S505 is performed to specify the form. By replacing the operation with another operation, the user's format number input operation can be omitted. For instance, the type of form can be specified by applying an image recognition technique, e.g., OCR or layout analysis. In the case of the form shown in FIG. 3, the format number and KAA051 at the bottom of the form may be read by OCR, and KAA051 is identified as the format number. Alternatively, the form shown in FIG. 3 may be subjected to layout analysis to identify the format as KAA051 having the similar format. Furthermore, it is also possible to identify the format by combining the layout analysis and OCR techniques. For instance, in the case of the form shown in FIG. 3, the format, as well as text such as name, address, and contract number, and the title are read. Based on similarity in the format, text, and text positions, it is identified that the format is KAA051.

Upon specifying the format of the form in the above-described manner, the masking position data acquisition unit 1053 of the PC 101 acquires the format number of the form KAA051, and transmits it to the masking position data storage unit 1044. From the masking position data storage unit 1044, masking position data of the format number KAA051 is acquired and stored, per step S506. In the case of the form shown in FIG. 3, the data format indicative of masking position data is “personal information=name, address, telephone number”.

In the character processor 1054 of the PC 101, the characters subjected to masking are processed, per step S507.

There are various character processing methods. Described herein is a method of constructing a character by combining particular dot patterns.

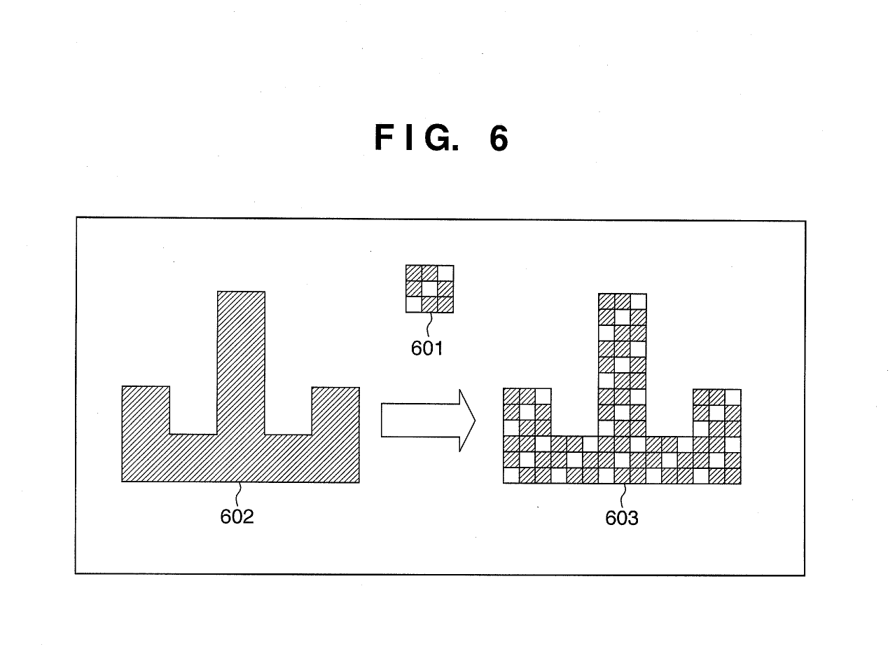

Since “name” is personal information, the name is changed to a particular dot pattern combination. The information (e.g., name, etc.) may be made up of characters from various alphabets, for example, English, Chinese, Japanese, etc. Japanese characters are used as an example herein. For instance, for a name [symbol] [symbol] all four characters [symbol] and [symbol] are changed to particular dot pattern combinations. The processing method is further described in detail with reference to FIG. 6. In FIG. 6, numeral 601 represents the particular dot pattern. The original character [symbol] with no embedded information is indicated by numeral 602. When the character 602 is expressed by the dot patterns 601, a processed character 603 is obtained. The characteristic according to the embodiment is to process a character that is personal information, and thus embed information. Thereafter, each of the characters [symbol] and [symbol] are similarly processed into dot patterns. Additionally, the information described in the items address and telephone number is also changed to dot patterns 601 in units of character. By virtue of the processing, information indicative of the masking target is embedded in all characters that are personal information. For characters that are not personal information, no particular processing is performed, as a matter of course.

When printing a document image where personal information is processed in units of character as described above, a mask-data-inserted paper document 111 is printed by the printer unit 109 of the MFP 102 through the processed document output unit 1055 using the driver of the PC 101, per steps S508 and S509.

The process generates a document wherein information indicative of masking positions is embedded. The information is embedded in the confidential information itself. The form generated by printing the document is substantially the same in appearance as the form printed under the state where the personal information protection mode is not selected. Therefore, the form can be used as a master copy for storage. In a case of printing a large number of pages, the toner consumption amount can be reduced in some degree.

In a case where the document is stored as an electronic data file instead of being printed out, the data is stored in the electronic data form in the mask-data-inserted document storage unit 1056 of the PC 101, per step S510.

Thus far, the processing of characters in the electronic form, and generating the information-embedded paper form or electronic form, has been described. The present invention is not limited thereto, and can similarly process characters in an already-generated paper form. More specifically, the paper form is read by the scanner unit 108 of the MFP 101, and the user's mode selection, per step S504, and format number input, per step S505, are performed through the display unit and operation unit of the MFP 102. The MFP 102 acquires masking position data in cooperation with the PC 101, per step S506). In the MFP 102, in accordance with the masking position data, characters of the read document are processed and information is embedded, per step S507, then printed, per step S509, or stored, per step S510.

### Masking Processing on Information-Embedded Document

The function is implemented chiefly by using the processed character masking processor 106 of the MFP 102.

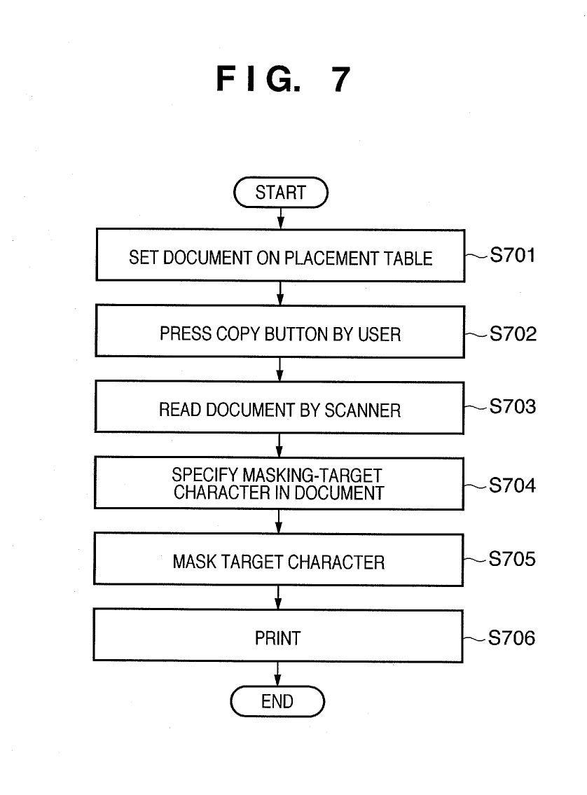

Masking is described with reference to FIG. 7, which shows the flowchart of the process.

The user places a mask-data-inserted paper document 111, which has been generated and printed as per the foregoing, on a document placement table or an automatic document feeder (ADF), per step S701, and presses a copy button, per step S702. The operation is the only operation required of the user to execute masking, and is the same as the regular copying operation.

In order to place emphasis on security, the following description provides an example of mandatory masking processing on characters designated as a masking target in the document. However, determination of necessity of masking may be made selectable through the display unit or operation unit of the MFP 102.

Returning to the flowchart in FIG. 7, the MFP 102 reads the set document using the scanner unit 108, per step S703, and extracts information indicative of the embedded masking position, thus specifying the masking-target characters, per step S704.

The target character specifying processing in step S704 is executed by the processed character masking processor 106. Details thereof are described hereinafter.

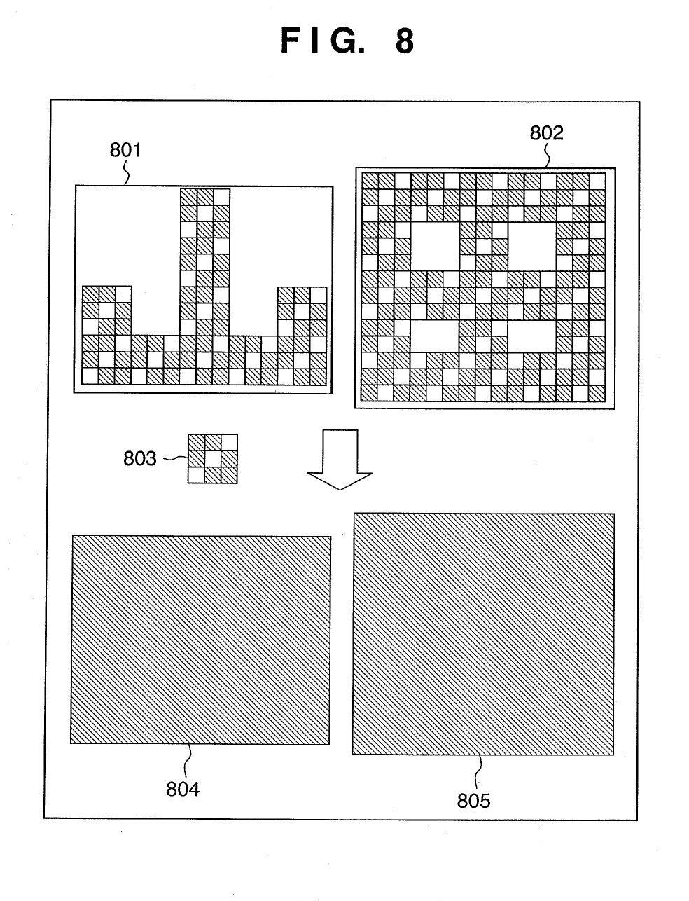

The processed character specifying unit 1061 employs a document analysis technique known as a general OCR pre-processing to specify a character area of the read document. The specified character area is divided into lines, and each of the lines is further divided into characters. Division into units of individual characters is performed to extract rectangles that conform to the character shape, as indicated by numerals 801 and 802 in FIG. 8.

All characters extracted as rectangles are subjected to matching with the dot pattern 803 in FIG. 8. As a result, a character including the dot pattern 803 can be extracted, and the character is specified as a masking target. For instance, from the personal information [symbol] as well as characters, or numbers, in the items address and telephone number, the dot pattern 803 is extracted, and the characters are specified as a masking target.

The masking target characters specified herein are extracted as rectangles as described above. The character masking processor 1062 then performs masking in a way that the rectangle's internal portions of the masking target character are filled in as indicated by numerals 804 and 805 in FIG. 8, per step S705.

The process is performed on all characters specified as personal information. As a result, a masked paper document 112 is formed, which is then subjected to printing by the printer unit 109, per step S706. Note although masking with black is given as an example herein, masking is not limited thereto. For instance, masking may be performed with white so that the characters appear to be deleted.

While the description is of an example of outputting a masked paper document based on a mask-data-inserted paper document, the form of input document is not limited thereto. For instance, masking can be applied to a mask-data-inserted electronic file that is stored in the mask-data-inserted document storage unit 1056, and which is generated in step S510 in FIG. 5. More specifically, the electronic file is transmitted to the MFP 102 to be processed by the processed character masking processor 106, and a masked paper document 112 is output by the printer unit 109. In other words, for an electronic file in which mask data is inserted, the processing in steps S704 to S706 in FIG. 7 can be executed to print out the masked paper document 112. According to the present embodiment, a masked paper document can be output directly from an electronic file.

Although the present embodiment has given an example where masking is performed on a processed character, it is also possible to consider masking an unprocessed character and performing no processing on a processed character. The rule to be adopted may be selected in accordance with the ratio of the entire number of characters to the masking number of characters, whereupon the document generation and masking may be executed.

Furthermore, the present embodiment has described as an example the system constructed with the PC 101 and the MFP 102. However, a server may be provided to take on part of the functions. For instance, all functions of the masking position data registration/storage unit 104 of the PC 101 or only the masking position data storage unit 1044 may be transferred to the server. In such a circumstance, since the server can uniformly manage the mask data, registration and usage of the mask data become available to plural PCs. Therefore, in large-scale offices, a more convenient system is realized.

Furthermore, the present embodiment, which has described a form sheet as an example, registers masking positions of the form sheet for each document format, and generates an information-embedded document using the registered masking positions. However, the present invention is not limited thereto. For instance, a document may be acquired by the document acquisition unit 1051 of the PC 101 and displayed on a display unit (not shown) such as a display screen, whereupon an operator may designate masking positions of the document using a designation unit (not shown) such as a mouse and a keyboard. In such a circumstance, the PC 101 need not include the masking position data registration/storage unit 104, the document format specifying unit 1052, and the masking position data acquisition unit 1053.

According to the embodiment, the image data where the confidential information itself includes information indicative of masking is stored or printed as a document. Therefore, the embodiment is resistant to a malicious attack that attempts to cut out only the information indicative of masking and avoid the masking of personal information.

By executing masking at the time of printing the document including the mask data, it is possible to ensure masking of the personal information component of an electronic document or a paper document including personal information. As a result, it is possible to prevent personal information from being leaked.

Note that, although the first embodiment has described the embedding method of information indicative of personal information for each character as a digital watermark using a predetermined dot pattern, the present invention is not limited thereto.

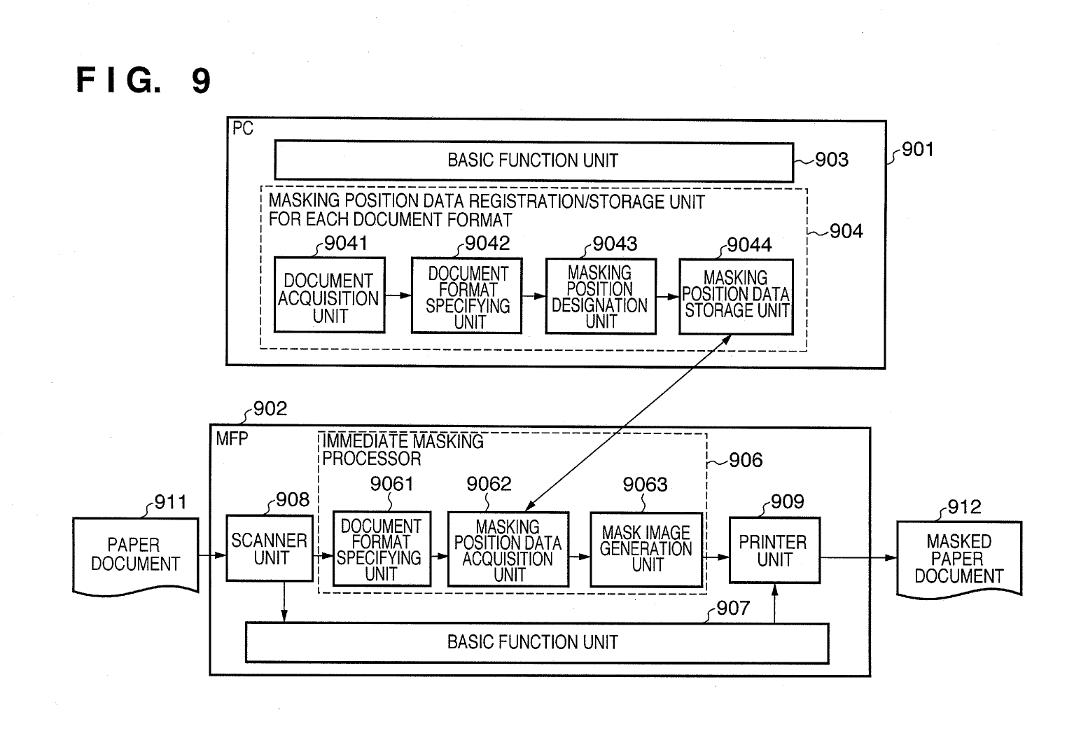

Hereinafter, a second embodiment of the present invention is described. The second embodiment is characterized by a masking process that differs from the first embodiment, which employs the masking position data for each format stored in the masking position data storage unit 1044, i.e., 9044 in FIG. 9 that is described in the first embodiment.

FIG. 9 is a block diagram showing a functional configuration of an image processing system according to the second exemplary embodiment. In FIG. 9, the image processing system according to the second embodiment includes a PC 901 and an MFP 902 having multi functions, e.g., for copying, scanning, printing, and the like. The PC 901 and MFP 902 are both connected to a network such as a LAN, and can exchange data such as images and protocol commands.

The PC 901 includes a basic function unit 903 that implements regular computer functions, e.g., calculation, display, input, output, and the like. The PC 901 further includes a masking position data registration/storage unit 904 that registers and stores masking position data for each document format. The masking position data registration/storage unit 904 includes a document acquisition unit 9041, a document format specifying unit 9042, a masking position designation unit 9043, and a masking position data storage unit 9044, which respectively correspond to the document acquisition unit 1041, the document format specifying unit 1042, the masking position designation unit 1043, and the masking position data storage unit 1044 included in the masking position data registration/storage unit 103 in FIG. 1. It is presumed that drivers for controlling the printer, scanner, and FAX functions of the MFP 902, as well as application software for document generation have already been installed in the PC 901.

The MFP 902 includes a basic function unit 907 that controls the basic functions of the MFP, e.g., copying, scanning, printing, image processing, and the like, a scanner unit 908 that reads an original document, a printer unit 909 that outputs printing paper, and an immediate masking processor 906.

The second embodiment is implemented by the following two steps: registration of document format and the masking position thereof, and next, masking processing on the document. In other words, the second embodiment does not perform information embedding on the document, which is performed in the first embodiment. Since the registration of document format and its masking position is similar to that of the first embodiment, a description thereof is not repeated. Hereinafter, the masking processing on the document is described in detail.

### Masking Processing on the Document

The function is implemented chiefly by using the immediate masking processor 906 of the MFP 902.

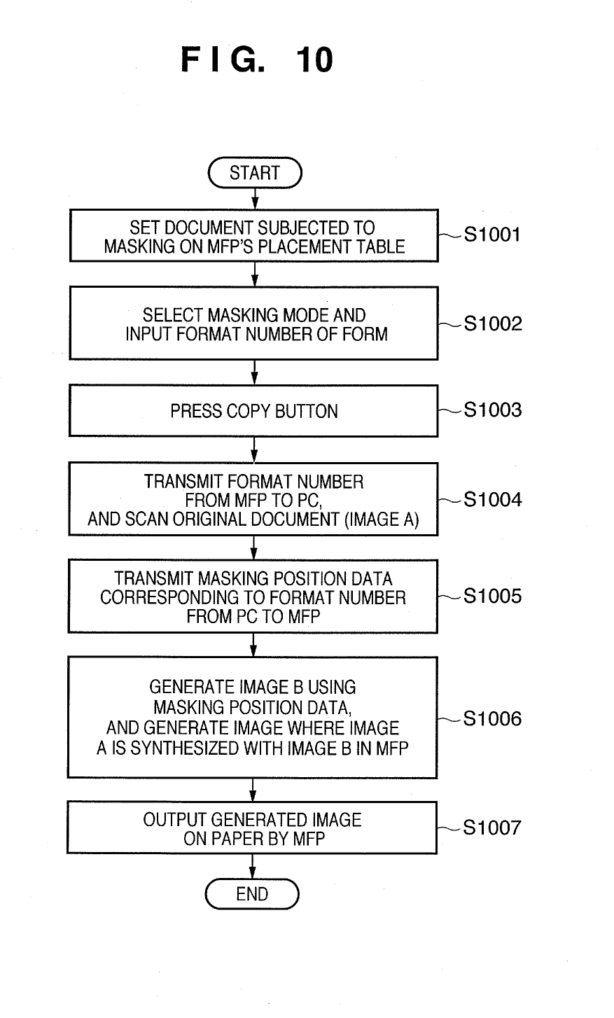

Masking is described with reference to FIG. 10, which shows the flowchart of this processing.

The user places a paper document 911 subjected to masking on a document placement table of the MFP 902, per step S1001. The document set herein is a normally printed form in which mask data is not inserted.

When the user selects a masking mode using the display unit or operation unit of the MFP 102, a message is displayed on the screen asking the user to input a format number of the form in the display unit. In accordance with the message on the screen, the user inputs the format number of the form, per step S1002. The user presses a copy button, per step S1003. In the MFP 902, a document format specifying unit 9061 acquires and stores the input format number of the form.

In the MFP 902, the acquired format number of the form is transmitted to the PC 901 through a masking position data acquisition unit 9062, and the document 911 placed on the document placement table is scanned, per step S1004. It is presumed that the document image obtained by scanning is an image A.

A masking position data storage unit 9044 of the PC 901 specifies masking position data corresponding to the format number of the form transmitted from the MFP 902, and transfers the specified information to the MFP 902, per step S1005.

In the MFP 902, a mask image generation unit 9063 generates image data, i.e., image B, in which, for instance, masked positions are blackened as shown in FIG. 4, using the masking position data specified by the PC 901. An image in which the image A is synthesized with the image B is generated, per step S1006. For instance, assume that the images A and B are both a binary image where black is expressed by pixel value 1 and white is expressed by pixel value 0. By performing an OR of the pixel values of the same pixel position, the personal information part in numerals 401, 402 and 404 in FIG. 4 is always masked by black, regardless of the contents of the image A. In other words, by utilizing the image B including masking positions, masked image data can be generated.

The masked image data is printed by the printer unit 909 of the MFP 902, and a masked paper document 912 is output, per step S1007.

For the masking position data stored in the masking position data storage unit 9044 of the PC 901, it is effective to store the image B in advance.

Furthermore, according to the second embodiment, by transferring part or all of the functions of the PC 901 to the MFP 902, for instance, masking can be performed by the MFP 902, or the second embodiment can be realized by the MFP 902 alone.

Furthermore, it is also possible to generate a masked document by transmitting the image A obtained by the MFP 902 to the PC 901, then generating the image B and synthesizing the image A with B, corresponding to steps S1005 to S1006 in FIG. 10 in the PC 901.

As described above, although the second embodiment does not generate a document including mask data as in the first embodiment, masking of the personal information part can be ensured when a paper document including personal information in a prescribed format is printed.

Following is a description of a third exemplary embodiment of the present invention.

The third embodiment is characterized by realizing respective processing described in the first and second embodiments by a computer.

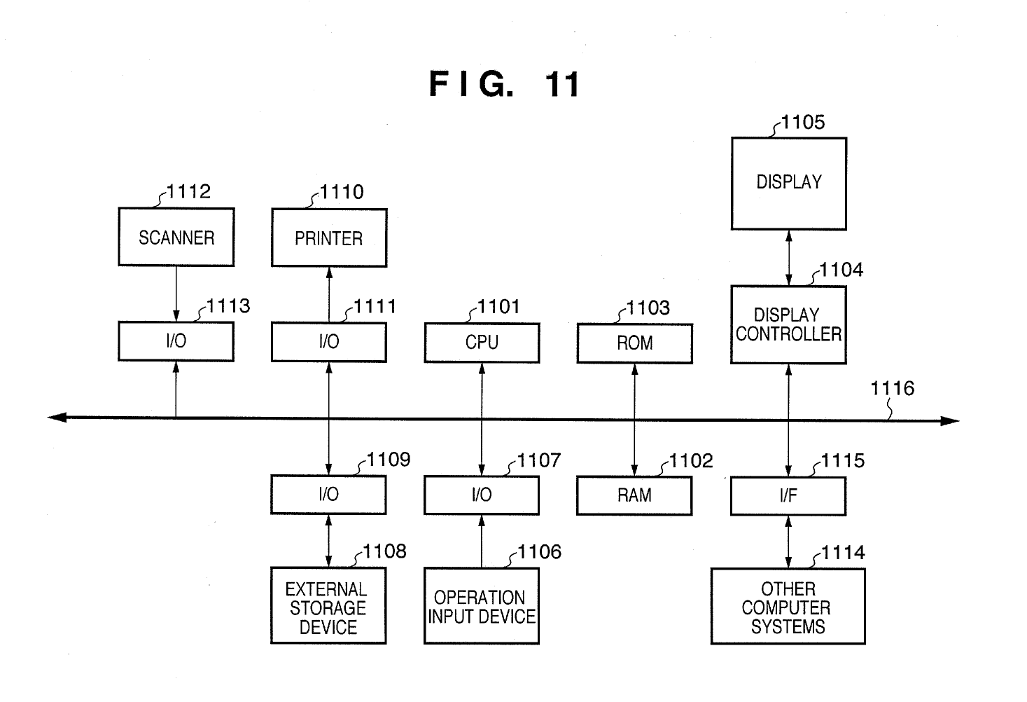

FIG. 11 is a block diagram showing a basic configuration of a computer according to the third embodiment. The computer having the configuration shown in FIG. 11 is capable of executing all functions of the first and second embodiments except that of the scanner and the printer. In other words, by describing respective functional configurations with program code and having the computer read the program, it is possible to have the computer implement all functions of the embodiments, except that of the scanner and the printer.

In FIG. 11, a CPU 1101 performs overall control of the computer, using programs and data stored in RAM 1102 and ROM 1103, and executes each process according to the embodiments. The RAM 1102 has an area for temporarily storing a program and data loaded from an external storage device 1108, or a program and data downloaded from other computer systems 1114 through an interface 1115. The RAM 1102 further provides an area necessary by the CPU 1101 to perform various processing. The ROM 1103 stores a function program, setting data and the like of the computer.

A display controller 1104 performs control processing to have a display unit 1105 display images, text, and the like. The display unit 1105 displays images, text, and the like. A CRT, a liquid crystal display, or the like may be used as the display unit 1105. An operation input device 1106 is configured with devices, e.g., a keyboard, a mouse, and the like, that can input various instructions to the CPU 1101. An I/O device 1107 notifies the CPU 1101 of various instructions input through the operation input device 1106. An external storage device 1108, which serves as a large-capacity information storage device such as a hard drive, stores an operating system (OS) and a program for causing the CPU 1101 to execute the process according to the embodiments, an input/output document image, and the like. Writing/reading information to/from the external storage device 1108 is performed through the I/O 1109.

A printer 1110 outputs documents and images. Image data subjected to printing is transmitted from the RAM 1102 to the printer through the I/O 1111, or from the external storage device 1108. For the printer 1110, for instance, an inkjet printer, a laser-beam printer, a thermal-transfer printer, a dot impact printer, and the like may be used. A scanner 1112 reads documents and images. The read input data is transmitted from the scanner to the RAM 1102 through the I/O 1113, or to the external storage device 1108.

A bus 1116 connects the CPU 1101, the ROM 1103, the RAM 1102, the I/O 1111, the I/O 1109, the display controller 1104, the I/F 1115, the I/O 1107, and the I/O 1113 in a way that they can communicate with one another.

Although the third embodiment describes an example where a computer executes the process for implementing the functions except that of the scanner and the printer, a portion of the process may be implemented by employing a dedicated hardware circuit incorporated in the scanner or the printer.

Note that each of the embodiments is a concrete example in implementing the present invention. Therefore, the interpretation of the technical scope of the present invention should not be limited because of the embodiments. In other words, the present invention can be implemented in various forms without departing from its technical idea and its main feature.

Per the foregoing, according to the third embodiment, it is possible to use a computer system to implement the image processing system described in the first and second embodiments.

The present invention can be realized in the form of, e.g., a system, an apparatus, a method, a program, or a storage medium, i.e., a recording medium. More specifically, the present invention can be applied to a system constituted by a plurality of devices, e.g., a host computer, an interface, an image capturing device, and a web application, or to an apparatus comprising a single device.

Note that the present invention is achieved by directly or remotely supplying a software program that implements the functions of the embodiments to a computer system or apparatus, reading the supplied program code by a computer of the system or apparatus, and executing the program code. The program in this case corresponds to the flowcharts shown in the drawings of the embodiments.

In such a circumstance, the form of program code may be of object code, a program executed by an interpreter, script data supplied to an operating system, or the like, provided that the program function is achieved.

For a recording medium supplying the program, for instance, a floppy disk, a hard disk, an optical disk, a magneto-optical disk (MO), CD-ROM, CD-R, CD-RW, a magnetic tape, a non-volatile memory card, ROM, DVD (DVD-ROM, DVD-R), and the like can be used.

As another program supplying method, the following method is possible. A website on the Internet is accessed using a browser of a client computer, and a computer program itself, or a compressed file including an automatic installation function according to the present invention is downloaded from the home page to a recording medium such as a hard drive. It is also possible to supply the program by dividing the program code constituting the program according to the present invention into plural files and downloading each of the plural files from different home pages. In other words, a World Wide Web server may allow a plurality of users to download the program file that is used by a computer to implement the functions of the present invention.

Furthermore, the program according to the present invention may be encrypted and stored in a storage medium, e.g., CD-ROM, for user distribution. In this case, a user who satisfies a predetermined condition is allowed to download decryption key data from a website on the Internet. In other words, the user can execute the encrypted program using the key data and install the program in a computer.

Additionally, the functions of the embodiments are achieved by executing the program read by the computer. Moreover, the functions of the embodiments can be implemented by an OS or the like working on a computer that performs part or the entire processes in accordance with designations of the program.

Furthermore, the program read from the recording medium may be written to a function expansion card which is inserted into the computer or in a memory provided in a function expansion unit which is connected to the computer, and the functions according to the embodiments may be realized. More specifically, a CPU or the like contained in the function expansion card or unit can perform part or the entire processes in accordance with designations of the program.

According to the present invention having the foregoing configuration, masking the confidential information part of a document can be ensured. Therefore, it is possible to prevent personal information leaks with certainty.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-155397 filed Jun. 2, 2006, which is hereby incorporated by reference herein in its entirety.

What is claimed is:

1. An image processing apparatus for generating a document image, which enables masking of confidential information at the time of outputting the confidential information, comprising:
a document input unit adapted to input a document image having a character image;
a masking position setting unit adapted to set masking position data indicative of a masking target position on the document image;
a mask data insertion unit adapted to insert mask data in the input document image, the mask data indicating that the character image corresponding to the masking position data is a masking target; and
a document output unit adapted to output the document image in which the mask data is inserted.

2. The image processing apparatus according to claim 1, further comprising:
a character specifying unit adapted to specify a character image, in which the mask data is inserted, in the document image output by the document output unit;
a masking unit adapted to mask the specified character image; and
an output unit adapted to output the document image on which masking has been performed.

3. The image processing apparatus according to claim 2, wherein the masking unit is adapted to fill in a rectangle's internal portion of the character image specified by the character specifying unit.

4. The image processing apparatus according to claim 1, wherein the masking position setting unit is adapted to register, for each format of a document image, masking position data indicative of a masking target position on the document image.

5. The image processing apparatus according to claim 4, wherein the mask data insertion unit comprises:
a document format specifying unit adapted to specify a format of the document image which is input by the document input unit;
a masking position acquisition unit adapted to acquire masking position data, which is set by the masking position setting unit, based on the specified format; and
a character processing unit adapted to process the character image in the document image based on the acquired masking position data.

6. The image processing apparatus according to claim 4, wherein the masking position setting unit comprises:
a document format input unit adapted to input a format of the document image;
a document format specifying unit adapted to specify the input format of the document image;
a masking position designation unit adapted to designate a masking position for the specified format; and
a masking position data storage unit adapted to store the document format data, which is specified by the document format specifying unit, in association with the masking position data designated by the masking position designation unit.

7. The image processing apparatus according to claim 1, wherein the document output unit is adapted to print the document image, or store the document image in an electronic data form.

8. The image processing apparatus according to claim 1, wherein the mask data insertion unit is adapted to insert the mask data in the character image as a digital watermark.

9. The image processing apparatus according to claim 1, wherein the mask data insertion unit is adapted to insert the mask data in the character image as a visible code.

10. An image processing apparatus for masking confidential information in a document image, comprising:
a masking position registration unit adapted to register masking position data, indicative of a masking target position on the document image, for each format of the document image;
a document input unit adapted to input the document image;
a masking unit adapted to mask the input document image based on the masking position data; and
an output unit adapted to output the document image on which masking has been performed.

11. The image processing apparatus according to claim 10, wherein the masking unit comprises:
a document format specifying unit adapted to specify a format of the document image which is input by the document input unit;
a masking position data acquisition unit adapted to acquire the masking position data, which is registered by the masking position registration unit, based on the specified format;
a masking image generation unit adapted to generate a masking image based on the acquired masking position data and the document image; and
an image synthesizing unit adapted to perform masking by synthesizing the document image with the masking image.

12. An image processing method of generating a document image, which enables to mask confidential information at the time of outputting the confidential information, comprising:
inputting a document image having a character image;
setting masking position data indicative of a masking target position on the document image;
inserting mask data in the input document image, the mask data indicating that the character image corresponding to the masking position data is a masking target; and
outputting the document image in which the mask data is inserted.

13. The image processing method according to claim 12, further comprising:
specifying a character image, in which the mask data is inserted, in the document image output;
masking the specified character image; and
outputting the document image on which masking has been performed.

14. An image processing method of masking confidential information in a document image, comprising:
registering masking position data, indicative of a masking target position on the document image, for each format of the document image;
inputting the document image;
masking the input document image based on the masking position data; and
outputting the document image on which masking has been performed.

15. A program stored in a recording medium that implements the image processing method according to claim 12 by being executed on the computer.

16. A recording medium storing the program according to claim 15.
